(19) United States
(12) Patent Application Publication
(10) Pub. No.: US 2016/0094425 A1
(43) Pub. Date: Mar. 31, 2016

(54) TELEMATICS BEHAVIOR CONFIGURATION SYSTEMS AND METHODS

(71) Applicant: Caterpillar Inc., Peoria, IL (US)

(72) Inventors: Robert Franklin SCHULZ, Dunlap, IL (US); Shawn Clayton SARVER, Metamora, IL (US); Caleb Mark JORDEN, Peoria, IL (US); John David PARKER, Peoria, IL (US); Jason Robert WHITE, Chillicothe, IL (US)

(73) Assignee: CATERPILLAR INC., Peoria, IL (US)

(21) Appl. No.: 14/500,169

(22) Filed: Sep. 29, 2014

(51) Int. Cl. H04L 12/26; H04L 12/24

(52) U.S. Cl. CPC H04L 43/08; H04L 41/0816; H04L 43/04

(57) ABSTRACT

Systems and methods are disclosed for configuring telematics behavior. The system includes a machine. The machine includes at least one communication module for communication to and from the machine over a network. The machine also includes a memory. The machine further includes a processor configured to receive a telematics behavior configuration file associated with a subscription number, the telematics behavior configuration file comprising at least a file transfer rule for communication over the network. The processor is also configured to store the telematics behavior configuration file in the memory. The processor is further configured to determine whether the network is available and, in response to a determination that the network is available, transfer and receive data over the network according to the telematics behavior configuration file.

### TECHNICAL FIELD

This disclosure relates generally to telematics and, more particularly, to systems and methods for configuring telematics behavior.

### BACKGROUND

Multiple number and types of machines operate within a remote worksite. Application of wireless communication technology to diagnose the machines from a remote location has improved maintenance process of the machines. Various data gathering systems may be used to collect data associated with state or condition of the monitored machines. The collected data may be transmitted to a central office system, which may subsequently transmit the collected data to customers associated with the machines, such that the customers can remotely monitor the machines based on the transmitted data. The monitoring of the vehicles and the associated data transmission is achieved by the use of telematics system.

The telematics system may include various components to collect data related to the machine performance. The telematics system may collect several types of data, for example, data regarding change in temperature of radiator coolant, change in speed, fuel injection frequency, location, and the like. The telematics system may transmit the collected data to the central office system after predefined time intervals or initiated in real time. The telematics system may transmit the collected data through a wired or wireless communication network, such as a Wi-Fi network, cellular network, a satellite network, and the like. In some cases, it is desirable to configure the behavior of the telematics system based on customer needs and available communication networks.

U.S. Pat. No. 7,551,063 (the '063) to Inbarajan discloses a vehicle email notification method and system that uses customer-selected severity settings to send special notifications to the subscriber. In particular, the '063 patent discloses that the vehicle email notification system builds and sends to the subscriber an email message that contains the dynamic vehicle information along with a diagnostic result indicative of the severity level of a vehicle condition, and that diagnostic result is compared to a customer-supplied severity setting to determine whether additional contact with the subscriber is needed. While the '063 patent may allow the subscriber to receive special notification based on customer-selected severity settings, the system of the '063 patent does not take into account the availability of the communication networks.

The disclosed methods and systems are directed to solve one or more of the problems set forth above and/or other problems of the prior art.

### SUMMARY

In one aspect, the present disclosure is directed to a machine. The machine includes at least one communication module for communication to and from the machine over a network, The machine also includes a memory. The machine further includes a processor configured to receive a telematics behavior configuration file associated with a subscription number, the telematics behavior configuration file comprising at least a file transfer rule for communication over the network. The processor is also configured to store the telematics behavior configuration file in the memory. The processor is further configured to determine whether the network is available and, in response to a determination that the network is available, transfer and receive data over the network according to the telematics behavior configuration file.

In another aspect, the present disclosure is directed to a central office. The central office includes a memory storing a plurality of telematics behavior configuration files, each one of the telematics behavior configuration files being associated with a subscription number. The central office also includes a processor configured to, in response to receiving an instruction to configure a telematics behavior of a machine according to a first subscription number, transfer a first telematics behavior configuration file associated with the first subscription number to the machine.

In yet another aspect, the present disclosure is directed to a method. The method includes receiving a telematics behavior configuration file associated with a subscription number, the telematics behavior configuration file comprising a file transfer rule for communication over a network. The method also includes storing the telematics behavior configuration file in a memory.

The method further includes determining whether the network is available and, in response to a determination that the network is available, transferring and receiving data over the network according to the telematics behavior configuration file.

### BRIEF DESCRIPTION OF THE DRAWINGS

FIG. 1 is a block diagram of a telematics behavior configuration system according to a disclosed embodiment.

FIG. 2 is a block diagram of a telematics unit of a machine, according to a disclosed embodiment.

FIG. 3 is a table of telematics behavior configuration files, according to a disclosed embodiment.

FIG. 4 illustrates a flow chart of an exemplary process of configuring telematics behavior performed by a processor of a machine, according to a disclosed embodiment.

FIG. 5 illustrates a flow chart of an exemplary process of configuring telematics behavior performed by a processor of a machine, according to another disclosed embodiment.

FIG. 6 illustrates a flow chart of an exemplary process of configuring telematics behavior performed by a processor of a machine, according to still another disclosed embodiment.

### DETAILED DESCRIPTION

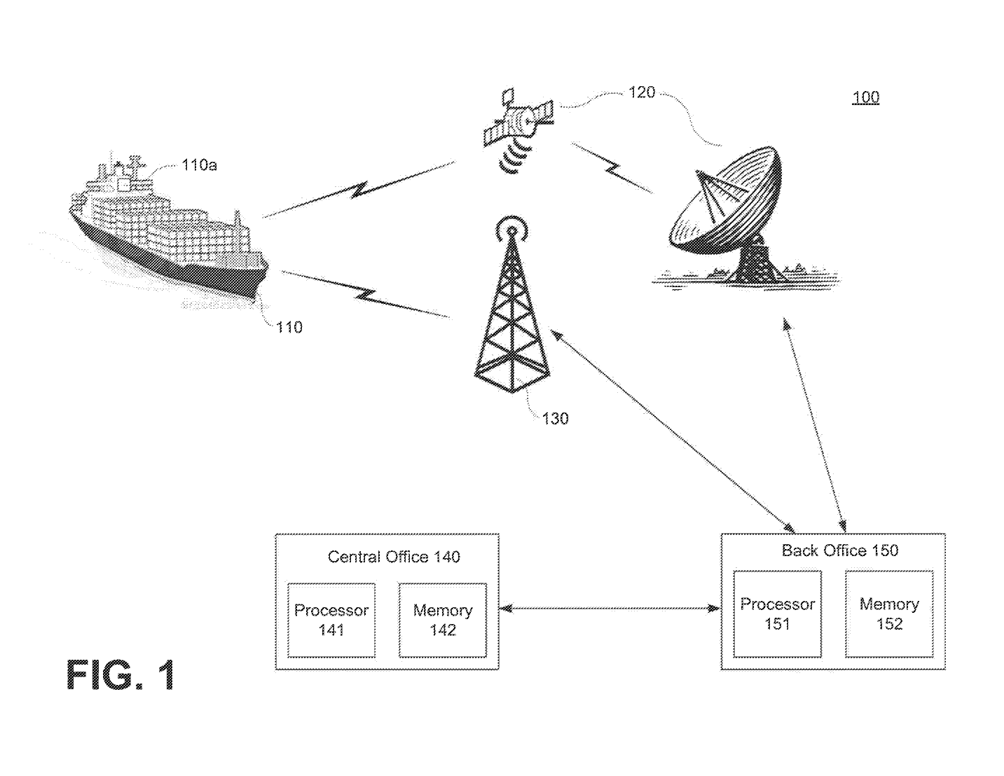

FIG. 1 is a block diagram of a telematics behavior configuration system 100 according to a disclosed embodiment. Telematics behavior configuration system 100 may include a machine 110, a satellite network 120, a cellular network 130, a central office 140, and a back office 150.

Machine 110 may be a fixed machine or mobile machine that may perform some type of operation associated with a particular industry, such as mining, construction, farming, etc. and operate between or within work environments (e.g., a construction site, mine site, power plant, etc.). A non-limiting example of a fixed machine includes an engine system operating in a plant or off-shore environment (e.g., off-shore drilling platform). Non-limiting examples of mobile machines include commercial machines, such as trucks, cranes, earth moving vehicles, mining vehicles, backhoes, material handling equipment, farming equipment, marine vessels, on-highway vehicles, or any other type of movable machine that operates in a work environment.

Machine 110 may include a telematics unit 110a attached thereto. Telematics unit 110a may monitor the operation condition of machine 110, and generate telematics data of the corresponding machine 110. Telematics unit 110a may also periodically transmit at least part of the telematics data to back office 150 over one of satellite network 120 or cellular network 130. Back office 150 may then transmit the telematics data to central office 140 or to a customer associated with machine 110, such as a user, an owner, or a dealer of machine 110. The telematics data may include one or more of operational parameters of machine 110, such as runtime, idle time, fuel consumption, and oil pressure, etc. The telematics data may also include diagnostic result of machine 110, such as the amount of oil life remaining (e.g., on a percentage basis 0-100%), the severity of the machine condition, and whether some action is required to address one or more of the machine conditions.

Telematics unit 110a may have a specific telematics behavior, which may be preconfigured based on customer needs and/or available networks. The telematics behaviors may include at least one of a file storage rule, a power management rule, a file transfer rule, and a call-in interval. The telematics behavior (e.g. file transmission rule) of telematics unit 110a of machine 110 may be preconfigured in accordance with a telematics behavior configuration file stored on-board of machine 110. In addition, the telematics behavior of telematics unit 110a of machine 110 may be varied based on the connectivity between machine 110 and satellite network 120 or cellular network 130. In one exemplary embodiment, machine 110 may be a marine vessel which may be out to sea, and may only be connected to satellite network 120. As a result, marine vessel 110 may transmit only part of its telematics data over satellite network 120 once every week. However, when marine vessel 110 arrives at a port, marine vessel 110 may be connected to cellular network 130, which is relatively more cost effective than satellite network 120. As a result, marine vessel 110 may transmit all of its telematics data over cellular network 130 everyday.

Central office 140 may represent one or more computing systems of an entity associated with machine 110, such as manufacturer, dealer, retailer, or any other entity that manufactures and/or maintains machine 110. Central office 140 may include a processor 141 and a memory 142 storing a plurality of telematics behavior configuration files, each being associated with a subscription number. A customer, such as the user or the owner of machine 110, may select a subscription number for machine 110. Processor 141 may, in response to receiving an instruction to configure the telematics behavior of machine 110, transmit the telematics behavior configuration file corresponding to the selected subscription number to machine 110.

Back office 150 may represent one or more computing systems of an entity that serves as an interface between central office 140 and different network carriers, such as the network carriers of satellite network 120 and cellular network 130. As described previously, back office 150 may receive telematics data transmitted from machine 110, and transmit the telematics data to central office 140 or to a customer associated with machine 110, such as a user, an owner, or a dealer of machine 110. Alternatively, back office 150 may host a web-based application through which the user or the owner of machine 110 can view, sort, manage, and/or analyze the telematics data. Back office 150 may include a processor 151 and a memory 152. Memory 152 may store a map relating each of a plurality of subscription numbers to one of a plurality of combinations of network plans. The network plan may be a satellite plan for communication over satellite network 120, or a cell plan for communication over cellular network 130. The network plan may include the amount of data that may be transmitted and received over the network each month, and the monthly cost. Memory 152 may also store a map relating each of a plurality of machine serial numbers to one of the plurality of subscription numbers. Processor 151 may use the information stored in memory 152 to generate monthly bills to be sent to the user or the owner of machine 110.

Although telematics behavior configuration system 100 in FIG. 1 only includes satellite network 120 and cellular network 130, those skilled in the art would appreciate that telematics behavior configuration system 100 may include other networks, such as a Wi-Fi network, a local area network (LAN), a wide area network (WAN), a processor area network (CAN), a dedicated intranet, or the Internet. Similarly, telematics behavior configuration system 100 may include more than one machine 110 that can communicate with central office 140 and back office 150 over satellite network 120 and cellular network 130.

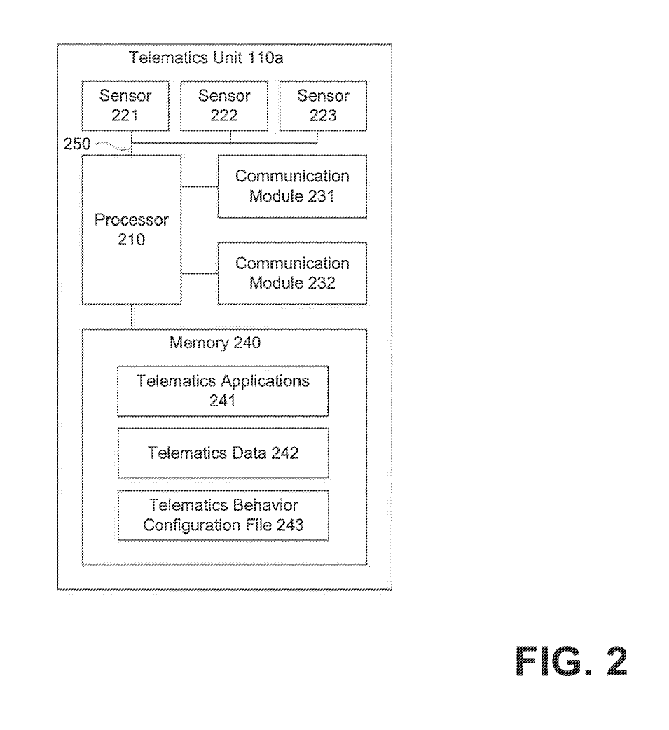

FIG. 2 is a block diagram of telematics unit 110a of machine 110, according to a disclosed embodiment. As illustrated in FIG. 2, telematics unit 110a may include a processor 210, sensors 221, 222, and 223, communication modules 231 and 232, and a memory 240.

Processor 210 may include one or more processing devices. For example, processor 210 may include one or more microprocessors from the Pentium™ or Xeon™ family manufactured by Intel™, the Turion™ family manufactured by AMD™, or any other type of processors. As shown in FIG. 2, processor 210 may be communicatively coupled to sensors 221, 222, and 223, communication modules 231 and 232, and memory 240 via an on-board network system 250. Processor 210 may be configured to execute computer program instructions to perform various processes and methods consistent with certain disclosed embodiments. In one exemplary embodiment, computer program instructions may be stored in a storage device (not shown), and may be loaded into memory 240 for execution by processor 210.

Sensors 221, 222, and 223 may gather data from various components and subsystems of machine 110. Sensors 221, 222, and 223 may be associated with and/or monitor a power source, a transmission, a traction device, a tool, an exhaust system, a suspension system, and/or other components and subsystems of machine 110. Sensors 221, 222, and 223 may measure and/or sense operational parameters based on the gathered sensor signals, such as, for example, engine RPM, ground speed, track/wheel slip, oil pressure, water temperature, boost pressure, oil contamination, exhaust temperature, NOx level, urea level, electric motor current, hydraulic pressure, system voltage, fuel consumption, payload weight, ground speed, distance traveled, transmission ratio, cycle time, start time, stop time, grade, a global or relative position of machine 110, brake temperature, etc. Sensors 221, 222, and 223 may each generate a signal corresponding to a value of the respective measured operational parameter (e.g., 170° F., 1.5 atm, 1,200 RPM, etc.). Sensors 221, 222, and 223 may generate or maintain other information such as, for example, time of day, date, etc. In some embodiments, sensors 221, 222, and 223 may be integrated within telematics unit 110a. In other embodiments, sensors 221, 222, and 223 may be distributed throughout machine 110. Although in the embodiment illustrated in FIG. 2, telematics unit 110a includes three (3) sensors 221, 222, and 223, those skilled in the art would appreciate that telematics unit 110a. may include more or less than three (3) sensors.

Communication modules 231 and 232 may include any hardware and/or software (e.g., a multiplexer/demultiplexer, a transceiver, a signal modulator, an amplifier, an antenna, etc.) that are configured to facilitate communications between machine 110 and central office 140 over respective networks 120 and 130. That is, communication module 231 may enable machine 110 to send and/or receive data over satellite network 120, and communication module 232 may enable machine 110 to send and/or receive data over cellular network 130.

Memory 240 may include a non-volatile, magnetic, semiconductor, tape, optical, removable, nonremovable, or other type of storage device or computer-readable medium. Memory 240 may store one or more telematics applications 241, telematics data 242, and a telematics behavior configuration file 243.

The one or more telematics applications 241 may enable processor 210 to analyze the data gathered by sensors 221, 222, and 223, and may generate diagnostic data regarding machine 110. One example of the telematics application 241 is a geo fence application, which may compare the current location of machine 110 to a predefined boundary, i.e., a geo fence, and may generate alert data when machine 110 approaches or move across the geo fence.

Telematics data 242 may include one or more of operational parameters of machine 110, such as runtime, idle time, fuel consumption, and oil pressure, etc. Telematics data 242 may also include diagnostic result of machine 110, such as the amount of oil life remaining (e.g., on a percentage basis 0-100%), the severity of the machine condition, and whether some action is required to address one or more of the machine conditions. Telematics data 242 may be stored in one or more tables, arrays, matrices, or other suitable data storage structures.

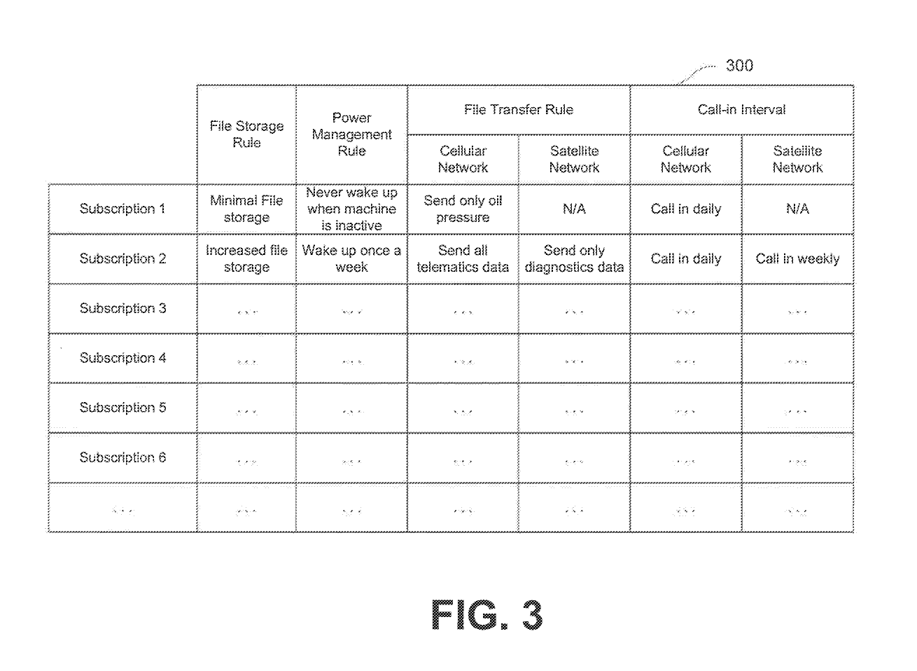

Telematics behavior configuration file 243 may be used to configure different types of telematics behaviors of machine 110. The different types of telematics behaviors may include at least one of a file storage rule, a power management rule, a file transfer rule, and a call-in interval. Some types of telematics behaviors, such as the file transfer rule and the call-in interval, may be further varied based on the connectivity between machine 110 and satellite network 120 or cellular network 130. Further description regarding telematics behavior configuration file 243 will be provided with reference to FIG. 3.

FIG. 3 is a table 300 of telematics behavior configuration files, according to a disclosed embodiment. Table 300 may be stored in memory 142 of central office 140, and may be maintained by processor 141 of central office 140. As illustrated in FIG. 3, table 300 may include rows indexed by subscription numbers, and columns indexed by different types of telematics behaviors, such as a file storage rule, a power management rule, a file transfer rule, and a call-in interval. Each subscription number may be associated with a unique telematics behavior configuration file. The cells in table 300 may include the actual telematics behavior configuration data. The file storage rule may specify rules for storing one or more telematics applications in machine 110. For example, the file storage rule may include rules for allocating the available memory space for storing the one or more telematics applications in memory 240 of machine 110. The power management rule may specify the telematics behavior of machine 110 When machine 110 is inactive, i.e., when machine 110 is keyed off. The file transfer rule may specify which part of telematics data machine 110 may transmit when it is connected to satellite network 120 or cellular network 130. The call-in interval may specify when machine 110 may connect to satellite network 120 or cellular network 130 to transmit or receive data.

Subscription 1 may be associated with a first telematics behavior configuration file, such that When a user or an owner of machine 110 selects subscription 1, processor 141 may transmit the first telematics behavior configuration file to machine 110. Subscription 1 may be applicable to a machine that includes only one communication module 232 for communication over cellular network 130. Subscription 1 may also be applicable to a machine that includes both of communication module 231 for communication over satellite network 120, and communication module 232 for communication over cellular network 130, but only communication module 232 is enabled. As illustrated in FIG. 3, the first telematics behavior configuration file associated with subscription 1 may include a file storage rule that specifies a minimal file storage rule for storing a single application in machine 110. For example, the minimal file storage rule may specify that the single application may use a certain percentage, e.g., 60%, or 40%, etc., of the available storage in machine 110. The first telematics behavior configuration file may include a power management rule which specifies that machine 110 may never wake up when it is inactive, i.e., when it is keyed off. The first telematics behavior configuration file may also include a file transfer rule for communication over cellular network 130, which specifies that machine 110 may send only operational data, e.g., oil pressure, when it is connected to cellular network 130. The first telematics behavior configuration file may further include a call-in interval for communication over cellular network 130, which specifies that machine 110 may connected to cellular network 130 once a day to transmit and receive data.

Subscription 2 may be associated with a second telematics behavior configuration file, such that when the user or the owner of machine 110 selects subscription 2, processor 141 may transmit the second telematics behavior configuration file to machine 110. Subscription 2 may also be applicable to a machine that includes both communication module 231 for communication over satellite network 120 and communication module 232 for communication over cellular network 130. As illustrated in FIG. 3, the second telematics behavior configuration file associated with subscription 2 may include a file storage rule that specifies an increased file storage rule for storing multiple applications in machine 110. For example, the increased file storage rule may specify that a first application may use a first percentage, e.g., 60%, of the available storage in machine 110, and that a second application may use a second percentage, e.g., 40%, of the available storage in machine 110. The second telematics behavior configuration file may include a power management rule which specifies that machine 110 may wake up once a week when it is inactive, i.e., when it is keyed off. The second telematics behavior configuration file may also include a first file transfer rule for communication over cellular network 130, and a second file transfer rule for communication over satellite network 120. The first file transfer rule may specify that machine 110 may send all of its telematics data when it is connected to cellular network 130. The second file transfer rule may specify that machine 110 may send only diagnostics data when it is connected to satellite network 120. The second telematics behavior configuration file may further include a first call-in interval for communication over cellular network 130, and a second call-in interval for communication over satellite network 120. The first call-in interval may specify that machine 110 may connected to cellular network 130 once a day to transmit and receive data. The second call-in interval may specify that machine 110 may connected to satellite network 120 once a week to transmit and receive data.

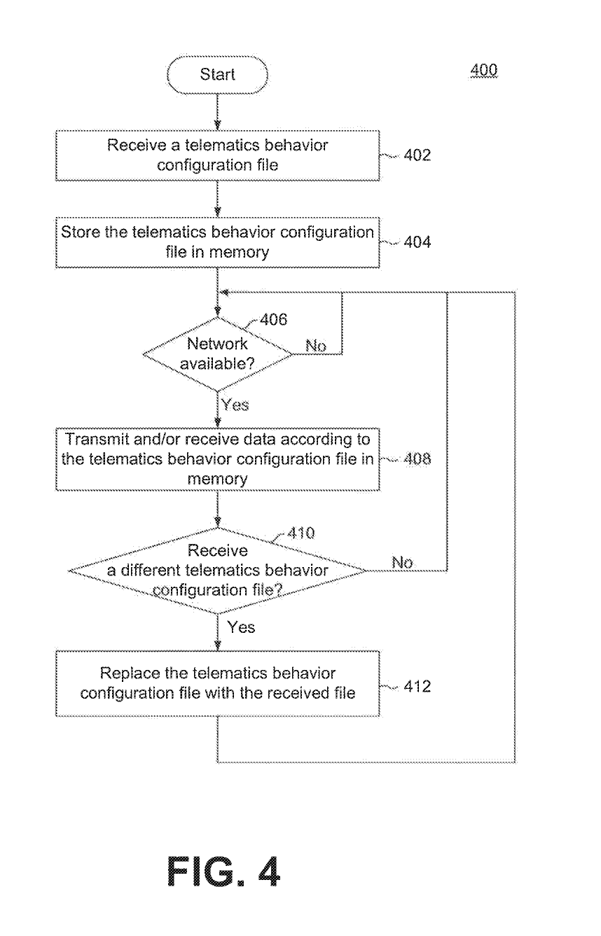

FIG. 4 illustrates a flow chart of an exemplary process 400 of configuring telematics behavior performed by processor 210 of machine 110, according to a disclosed embodiment. Initially, machine 110 may receive a telematics behavior configuration file (step 402), The telematics behavior configuration file may be associated with a subscription number selected by a customer (e.g., owner, user, etc.) associated with machine 110. The telematics behavior configuration file may include a file storage rule, a power management rule, a file transfer rule for communication over a network, and a call-in interval for communication over the network. In response to receiving the telematics behavior configuration file, processor 210 may store the telematics behavior configuration file in memory 240 (step 404), Processor 210 may determine whether the network is available (step 406). In response to a determination that the network is not available (step 406: No), processor 210 may repeat step 406 to determine whether the network is available. In response to a determination that the network is available (step 406: Yes), processor 210 may transmit and/or receive data over the network according to the telematics behavior configuration file (step 408). Processor 210 may also determine whether machine 110 has received a telematics behavior configuration file different from the one stored in memory 240 (step 410). In response to a determination that machine 110 has not received the different telematics behavior configuration file (step 410: No), processor 210 may return to step 406 to determine whether the network is available. In response to a determination that machine 110 has received the different telematics behavior configuration file (step 410: Yes), processor 210 may replace the telematics behavior configuration file stored in memory 240 with the received telematics behavior configuration file (step 412). Processor 210 may then return to step 406 to determine whether the network is available.

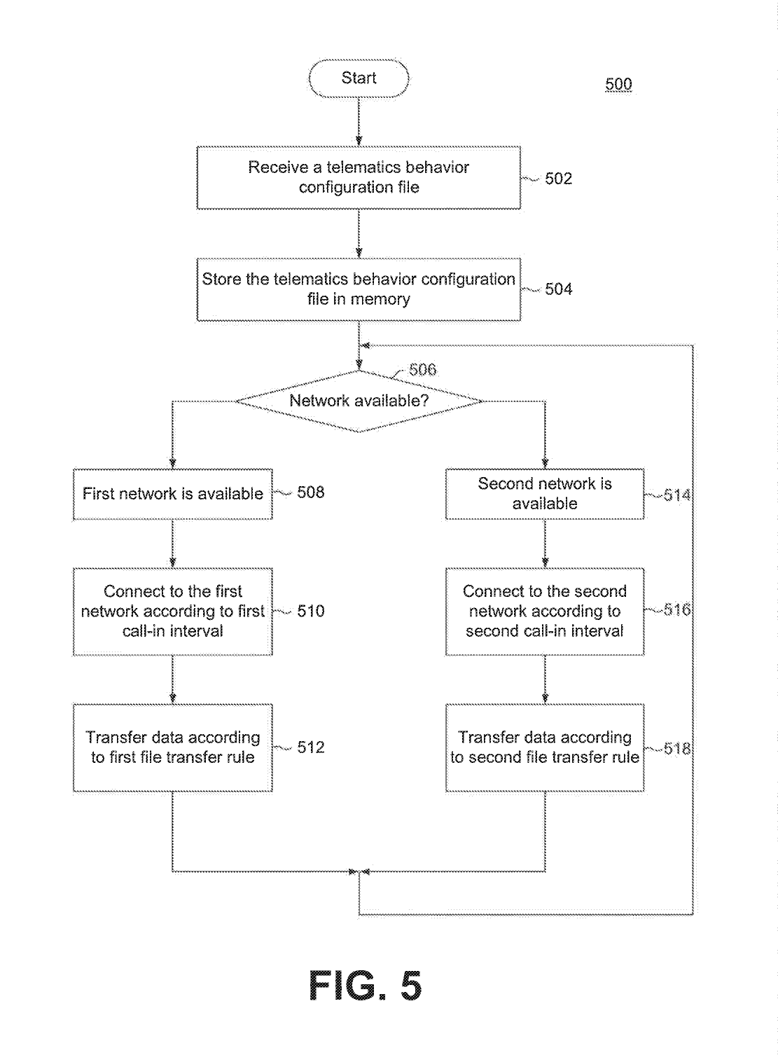

FIG. 5 illustrates a flow chart of an exemplary process 500 of configuring telematics behavior performed by processor 210 of machine 110, according to another disclosed embodiment. Initially, machine 110 may receive a telematics behavior configuration file (step 502). The telematics behavior configuration file may be associated with a subscription number selected by a customer (e.g., owner, user, etc.) associated with machine 110. The telematics behavior configuration file may include a first file transfer rule and a first call-in interval for communication over a first network, and a second file transfer rule and a second call-in interval for communication over a second network. In response to receiving the telematics behavior configuration file, processor 210 may store the telematics behavior configuration file in memory 240 (step 504). Processor 210 may determine whether any one of the first network and the second network is available (step 506). Processor 210 may determine that the first network is available (step 508). In response to such determination, processor 210 may connect to the first network according the first call-in interval (step 510), and may transfer data over the first network according to the first file transfer rule (step 512). Then, processor 210 may return to step 506 to determine whether any one of the first network and the second network is available. Alternatively, processor 210 may determine that the second network is available (step 514). In response to such determination, processor 210 may connect to the second network according the second call-in interval (step 516), and may transfer data over the second network according to the second file transfer rule (step 518). Then, processor 210 may return to step 506 to determine whether any one of the first network and the second network is available.

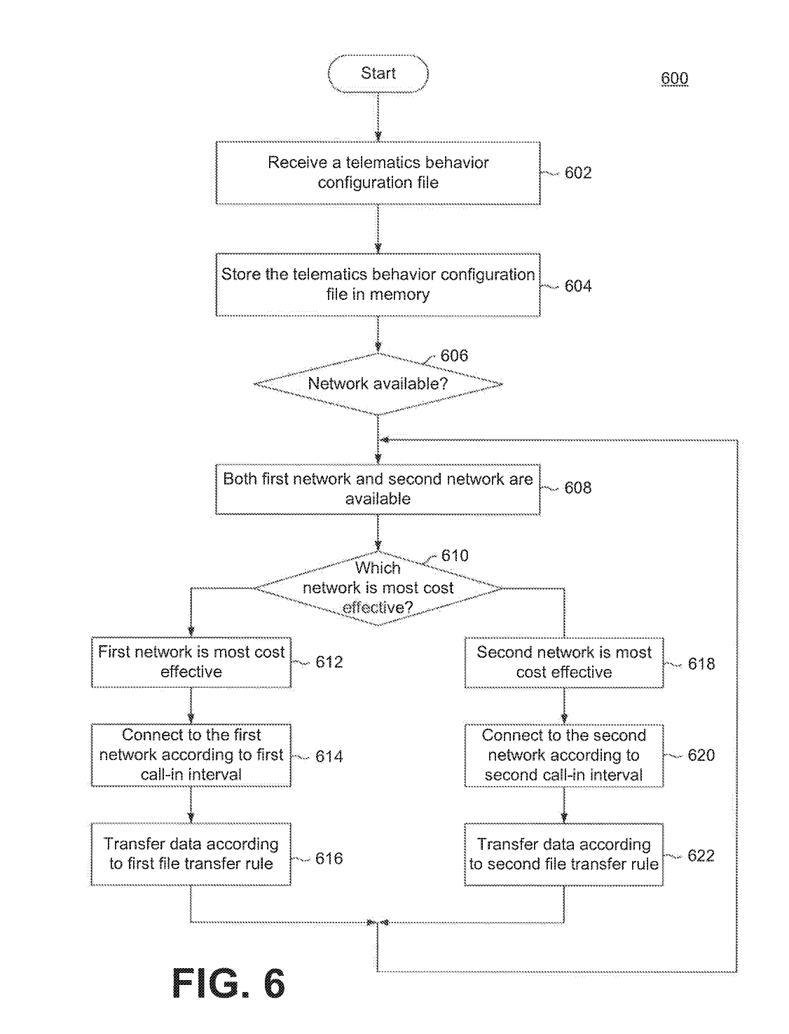

FIG. 6 illustrates a flow chart of an exemplary process 600 of configuring telematics behavior performed by processor 210 of machine 110, according to still another disclosed embodiment. Initially, machine 110 may receive a telematics behavior configuration file (step 602). The telematics behavior configuration file may include a first file transfer rule and a first interval for communication over a first network, and a second file transfer rule and a second interval for communication over a second network. In response to receiving the telematics behavior configuration file, processor 210 may store the telematics behavior configuration file in memory 240 (step 604). Processor 210 may determine whether any one of the first network and the second network is available (step 606). Processor 210 may determine both the first network and the second network are available (step 608). Then, processor 210 may select one of the first network and the second network that is most cost effective. In particular, processor 210 may determine which one of the first network and the second network is most cost effective (step 610). Processor 210 may determine that the first network is most cost effective (step 612). In response to such determination, processor 210 may connect to the first network according the first call-in interval (step 614), and may transfer data over the first network according to the first file transfer rule (step 616). Then, processor 210 may return to step 606 to determine whether any one of the first network and the second network is available. Alternatively, processor 210 may determine that the second network is most cost effective (step 618). In response to such determination, processor 210 may connect to the second network according the second call-in interval (step 620), and may transfer data over the second network according to the second file transfer rule (step 622). Then, processor 210 may return to step 606 to determine whether any one of the first network and the second network is available.

### INDUSTRIAL APPLICABILITY

The disclosed telematics system and method may configure telematics behavior of one or more machines by specifying a set of rules for file storage, power management, file transfer, and call-in interval. The set of rules may be further specified based on customer needs and available communication networks, such as a cellular network, a satellite network, a WiFi network, and an Ethernet network. The disclosed telematics system and method may facility a dual mode communication, i.e., communication over two different networks, or multi mode communication, i.e., communication over three or more networks. Specifically, the telematics behavior of machine 110 may be configured based on a customer-selectable subscription number. The customized telematics behavior provides for efficient communication and remote management of machines and fleets.

It will be apparent to those skilled in the art that various modifications and variations can be made to the disclosed telematics configuration system. Other embodiments will be apparent to those skilled in the art from consideration of the specification and practice of the disclosed parts forecasting system. It is intended that the specification and examples be considered as exemplary only, with a true scope being indicated by the following claims and their equivalents.

What is claimed is:

1. A machine, comprising:
at least one communication module for communication to and from the machine over a network;
a memory; and
a processor configured to:
receive a telematics behavior configuration file associated with a subscription number, the telematics behavior configuration file comprising at least a file transfer rule for communication over the network;
store the telematics behavior configuration file in the memory;
determine whether the network is available; and
in response to a determination that the network is available, transfer and receive data over the network according to the telematics behavior configuration file.

2. The machine of claim 1, wherein said telematics behavior configuration file is a first telematics behavior configuration file associated with a first subscription number, and the processor is further configured to:
receive a second telematics behavior configuration file associated with a second subscription number;
replace the first telematics behavior configuration file with the second telematics behavior configuration file; and
transfer and receive data over the network according to the second telematics behavior configuration file.

3. The machine of claim 1, wherein,
the memory further stores one or more telematics applications, and
the telematics behavior configuration file further includes a file storage rule for storing the one or more telematics applications in the memory.

4. The machine of claim 1, wherein the telematics behavior configuration file further includes a call-in interval for connecting to the network.

5. The machine of claim 1, wherein the telematics behavior configuration file further includes a power management rule.

6. The machine of claim 1, wherein,
the at least one communication module includes a first communication module for communication over a first network, and a second communication module for communication over a second network,
the telematics behavior configuration file includes a first file transfer rule for communication over the first network, and a second file transfer rule for communication over the second network.

7. The machine of claim 6, wherein, the processor is further configured to:
determine that one of the first network and the second network is available; and
transfer and receive data over the available one of the first network and the second network according to one of the first file transfer rule and the second file transfer rule associated with the available one of the first network and the second network.

8. The machine of claim 6, wherein, the processor is further configured to:
determine that both of the first network and the second network is available;
select one of the first network and the second network that is most cost effective; and
transfer and receive data over the selected one of the first network and the second network according to one of the first file transfer rule and the second file transfer rule associated with the selected one of the first network and the second network.

9. The machine of claim 1, wherein,
the at least one communication module includes a first communication module for communication over a first network, and a second communication module for communication over a second network,
the telematics behavior configuration file includes a first call-in interval for communication over the first network, and a second call-in interval for communication over the second network; and
the processor is further configured to:
determine that one of the first network and the second network is available; and
connect to the available one of the first network and the second network according to one of the first call-in interval and the second call-in interval associated with the available one of the first network and the second network.

10. The machine of claim 1, wherein the network is one of a cellular network, a satellite network, a Wi-fi network, or a wired network.

11. A central office, comprising:
a memory storing a plurality of telematics behavior configuration files, each one of the telematics behavior configuration files being associated with a subscription number; and
a processor configured to, in response to receiving an instruction to configure a telematics behavior of a machine according to a first subscription number, transfer a first telematics behavior configuration file associated with the first subscription number to the machine.

12. The telematics system of claim 11, wherein each one of the telematics behavior configuration file includes at least one file transfer rule for transmitting data from the machine over at least one network.

13. The telematics system of claim 11, each one of the telematics behavior configuration file includes an on-board file storage rule.

14. The telematics system of claim 11, each one of the telematics behavior configuration file includes a call-in interval.

15. The telematics system of claim 11, each one of the telematics behavior configuration file includes a power management rule.

16. A method, comprising:
receiving a telematics behavior configuration file associated with a subscription number, the telematics behavior configuration file comprising a file transfer rule for communication over a network;
storing the telematics behavior configuration file in a memory;
determining whether the network is available; and
in response to a determination that the network is available, transferring and receiving data over the network according to the telematics behavior configuration file.

17. The method of claim 16, wherein said telematics behavior configuration file is a first telematics behavior configuration file associated with a first subscription number, and method further includes:
receiving a second telematics behavior configuration file associated with a second subscription number;
replacing the first telematics behavior configuration file with the second telematics behavior configuration file; and
transferring and receiving data over the network according to the second telematics behavior configuration file.

18. The method of claim 16, wherein the telematics behavior configuration file includes a first file transfer rule for communication over a first network, and a second file transfer rule for communication over a second network, and the method further includes:
determining that one of the first network and the second network is available;
transferring and receiving data over the available one of the first network and the second network according to one of the first file transfer rule and the second file transfer rule associated with the available one of the first network and the second network.

19. The method of claim 16, wherein the telematics behavior configuration file includes a first file transfer rule for communication over a first network, and a second file transfer rule for communication over a second network, and the method further includes:
determining that both of the first network and the second network is available;
selecting one of the first network and the second network that is most cost effective; and
transferring and receiving data over the selected one of the first network and the second network according to one of the first file transfer rule and the second file transfer rule associated with the selected one of the first network and the second network.

20. The method of claim 16, wherein the telematics behavior configuration file includes a first call-in interval for communication over a first network, and a second call-in interval for communication over a second network, and the method includes:
determining that one of the first network and the second network is available;
connecting to the available one of the first network and the second network according to one of the first call-in interval and the second call-in interval associated with the available one of the first network and the second network.
